(19) United States
(12) Patent Application Publication
(10) Pub. No.: US 2021/0203861 A1
(43) Pub. Date: Jul. 1, 2021

(54) THERMAL IMAGING

(71) Applicant: HEWLETT-PACKARD DEVELOPMENT COMPANY, L.P., Spring, TX (US)

(72) Inventors: Joshua Peter YASBEK, Vancouver, WA (US); Todd GOYEN, Vancouver, WA (US); David SORIANO, Vancouver, WA (US); Asa WEISS, Vancouver, WA (US); Arthur H. BARNES, Vancouver, WA (US)

(73) Assignee: HEWLETT-PACKARD DEVELOPMENT COMPANY, L.P., Houston, TX (US)

(21) Appl. No.: 16/075,222

(22) PCT Filed: Jul. 11, 2017
(86) PCT No.: PCT/US2017/041516

§ 371 Date: Aug. 3, 2018

(51) Int. Cl. H04N 5/33; G01J 5/22

(52) U.S. Cl. CPC H04N 5/33; G01J 2005/0077; G01J 5/22

(57) ABSTRACT

Some examples include a thermal imaging assembly, comprising a thermal imaging device including a thermal sensor, a transistor to generate heat, a thermal jacket forming a cavity to house the thermal imaging device, the thermal jacket forming a space around the thermal imaging device, the thermal jacket thermally coupled to the transistor to transmit heat generated by the transistor to the cavity, and an insulative shell disposed around the thermal jacket to maintain a temperature of the thermal imaging device within the insulative shell.

### BACKGROUND

Thermal imaging devices, such as non-contact thermal cameras, are used to provide feedback in systems that generate heat, such as additive manufacturing machines (e.g., 3D printers). For instance, by monitoring the heat generated within a system, extreme heating conditions that might otherwise damage the system, or parts of the system, can be detected.

### BRIEF DESCRIPTION OF THE DRAWINGS

FIG. 1A is a schematic side cross-sectional view of a thermal imaging assembly according to an example of the present disclosure.

FIG. 1B is a schematic top cross-sectional view of the thermal imaging assembly of FIG. 1A according to an example of the present disclosure.

FIG. 2 is a block diagram of a closed loop feedback system in accordance with aspects of the present disclosure.

FIG. 3 is a perspective cross-sectional view of a thermal imaging assembly according to another example of the present disclosure.

FIG. 4 is a schematic view of a thermal imaging assembly within an additive manufacturing machine according to an example of the present disclosure.

FIG. 5 is a flow chart of an example method of controlling thermal conditions of a thermal imaging device according to an example of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Cameras or other types of thermal imaging devices can be employed in various manufacturing environments, including highly thermally dynamic environments such as additive manufacturing machines. It is desirable to maintain the thermal imaging device in a constant well-defined temperature, or range of temperature, environment to aid accuracy of the thermal sensor. It is desirable to control the temperature of a thermal camera for thermal feedback accuracy and stability during an additive manufacturing process, for example. It is desirable to maintain the thermal camera in an isothermal state. Accuracy of measurements detected by thermal imaging device can be influenced, or effected, by the temperature of the sensor itself. Consistency of mathematical models, or techniques, that relate a signal generated by the thermal sensor to the temperature of the observed region by the thermal sensor can decrease as the sensor's temperature variance is incorporated. This effect can be greater for a time variant temperature profile of a thermal sensor. It is desirable to maintaining a thermal imaging device (e.g., thermal camera) at a constant temperature to improve the measurement accuracy of the thermal sensor.

Thermal imaging devices can be employed to detect that a material in additive manufacturing machine is reaching a desired temperature for proper fusion, for example. When employed in an additive manufacturing machine, the ambient temperature can be higher than a tolerable level for the sensor to function properly. An enclosure can be included to aid in protecting the thermal imaging device from accumulation of contaminants, such as powders, and thermal influences within the additive manufacturing environment. An enclosure can be placed over the thermal imaging device (e.g., thermal camera) and the volume around the sensor purged of hot, dust infused air with cold and clean air. Insulation of the thermal camera can be useful to direct currents of cold air around the thermal camera and reduce internal temperature gradients. Temperature control within the enclosure can also be aided by heat transference generated from a heat generating device. The temperature of the thermal imaging device can be further moderated, or controlled, with heat generated by a heating device, such as a transistor. Dissipative heat generated by a transistor, or transistors, can be employed to moderate the temperature of the thermal imaging device. In this manner, the thermal imaging device can be maintained at a desired temperature(s) with controlled heat conductance and insulation.

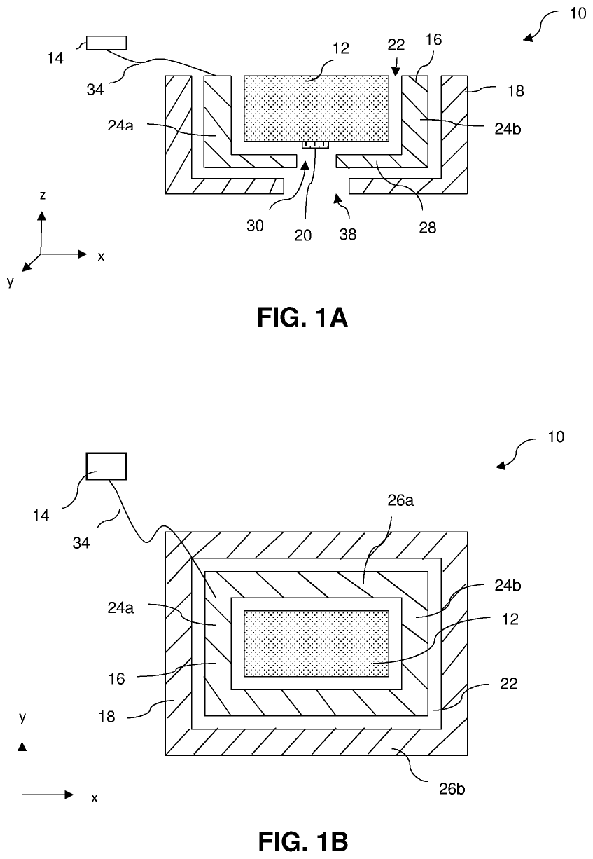

FIGS. 1A and 1B are schematic side and top cross-sectional views of a thermal imaging assembly 10 in accordance with aspects of the present disclosure. Thermal imaging assembly 10 includes a thermal imaging device 12, a transistor 14, a thermal jacket 16, and an insulative shell 18. Insulative shell 18 is disposed around thermal jacket 16 and thermal jacket 16 is disposed around thermal imaging device 12 within insulative shell 18. Thermal jacket 16 is highly thermally conductive. Insulative shell 18 is highly thermally insulative. Thermal imaging assembly 10 can work to control the temperature of thermal imaging device 12 seated within thermal jacket 16 and insulative shell 18 through convection and conduction as described further below.

Thermal imaging device 12 can be any of a variety of thermal imaging devices, such as a thermal camera, for capturing thermal data including temperature. In one example, thermal imaging device 12 is a non-contact thermal imaging device. Thermal imaging device 12 can be an infrared imaging device. In one example, thermal imaging device 12 is a bolometer. Thermal imaging device 12 includes a sensor 20 to sense a thermal image of a target object. The thermal image obtained by sensor 20 can include a thermal profile of the target object.

Thermal imaging device 12 is disposed within a cavity 22 formed, or defined within thermal jacket 16. Thermal jacket 16 and cavity 22 can be any appropriate size or shape. Cavity 22 is sized and shaped to accommodate thermal imaging device 12 and create a space, or gap, between the thermal imaging device 12 and an interior surface 23 of thermal jacket 16 defined by cavity 22. In one example, cavity 22 is generally centered within thermal jacket 16 along x and y axes. In one example, thermal jacket 16 includes opposing sides 24a, 24b and 26a, 26b and a bottom 28. In one example, sides 24a, 24b can be parallel with one another and generally of equivalent wall thickness. Similarly, sides 26a, 26b can be parallel with one another and generally of equivalent wall thickness. In one example, bottom 28 is generally planar and perpendicular to sides 24a, 24b, 26a, 26b. In one example, bottom 28 has a wall thickness that is less than the thickness of sides 24a, 24b, 26a, 26b. In one example, a top 29 is included opposite bottom 28.

Thermal jacket 16 includes an opening 30 aligned and sized to accommodate a field of view of sensor 20. Opening 30 can be extended through bottom 28, as shown, or any appropriate side of thermal jacket 16 to accommodate sensor 20. A window 32 can be disposed across opening to aid in maintaining a thermal state of thermal imaging device. Window 32 can be infrared transparent and scratch resistant.

Thermal jacket 16 has a very small Biot number, (e.g., less than 0.1) and is highly isothermal. Thermal jacket 16 can be formed of a highly thermally conductive material that can conduct thermal energy input throughout thermal jacket 16 with minimal thermal gradient across thermal jacket 16. For example, thermal jacket 16 can be formed of aluminum or other appropriate material. Thermal jacket 16 can be a solid body, a hollow shell, or a shell of a first material with second material disposed within the shell. In one example, thermal jacket 16 is formed as a closed aluminum shell. In one example, thermal jacket 16 is at least partially formed of a ceramic fill silicon foam. In one example, thermal jacket 16 is formed of an aluminum shell with ceramic fill silicon foam disposed within the shell. Thermal jacket 16 is thermally connected to transistor 14. Transistor 14 is thermally conductively coupled to thermal jacket 16 to transfer dissipative heat generated by transistor 14 to thermal jacket 16. One or more transistors 14 can be included, as appropriate.

In one example, a thermal interface 34 is included to fully extend between transistor 14 and thermal jacket 16. Transistor 14 can be thermally connected to thermal jacket 16 via any one or multiple thermal interfaces 34. In some examples, thermal interface 34 is electrically nonconductive. Thermal interface 34 can include wire, thermally conductive foam (e.g., ceramic filled silicon foam), thermally conductive paste, or other suitable thermally conductive material. In some examples, thermal interface 34 is compliant or flexible and conforms to accommodate space tolerances between transistor 14 and thermal jacket 16.

Insulative shell 18 is disposed, or extends, around thermal jacket 16. Insulative shell 18 is thermally and electrically insulative. Thermal jacket 16 can be maintained within insulative shell 18 in a spaced relationship with minimal contact formed between thermal jacket 16 and insulative shell 18 to minimize conductive thermal losses into the insulative shell 18. Insulative shell 18 can include an opening 38 aligned with opening 30 in thermal jacket 16 and the field of view of thermal imaging device 12. In one example, insulative shell 18 is formed of a plastic. In one example, insulative shell 18 is formed of a thermoplastic such as a modified polyphenylene.

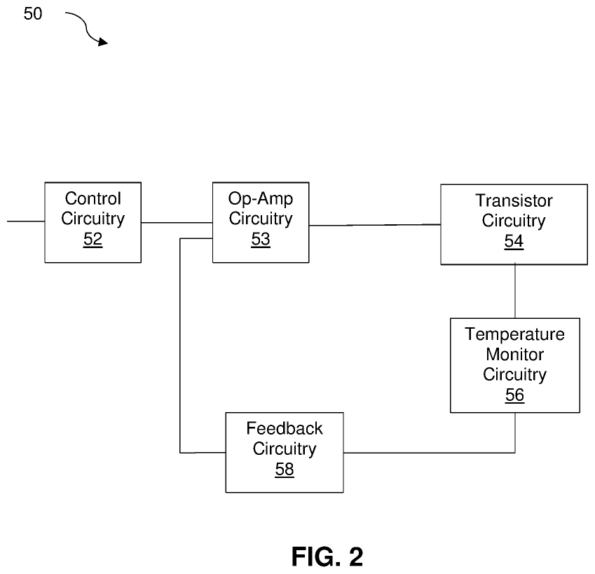

FIG. 2 is a block diagram of a closed loop feedback system 50 in accordance with aspects of the present disclosure. System 50 includes control circuitry 52, op-amp circuitry 53, transistor circuitry 54, temperature monitor circuitry 56, and feedback circuitry 58. Op-amp circuitry 53 drives transistor circuitry 54 that functions as a heater. Temperature monitor circuitry 56 monitors the temperature of transistor circuitry 54. Feedback circuitry 58 provides feedback from temperature monitor circuitry 56 to op-amp circuitry 53. Control circuitry 52 provides input and control to op-amp circuitry 53.

Transistor circuitry 54 includes transistor 14. Transistor 14 can be a NPN or N-type Metal Oxide Field Effect Transistor (MOSFET), although other transistors (e.g., P-type, or PNP) or architectures that can be held partially on would also be suitable. Heat from transistor 14 can be controlled by operating transistor circuitry 54 as a variable resistor. Feedback circuitry 58 controls current, providing for a linear relationship between control voltage and power output. This can provide an advantage for a stable system, as most heaters using a resistor would have a non-linear relationship between control voltage and power.

Although illustrated as a closed loop system, system 50 can be run open loop, or closed loop. In one example, control circuitry 52 and feedback circuitry 58 employ Proportional Integral (PI) control. Besides the linear voltage to power relationship, transistor 14 also provides a very low cost compact package that can spread heat out and be coupled with a heat sink. Typical power resistors are much larger and more costly. In one example, system 50 can operate at approximately 150 degrees Celsius. In one example, higher temperature transistors can be employed. In another example, system 50 can operate at ambient temperatures. Temperature monitor circuitry 56 can include a temperature sensor to close the loop. The temperature sensor can be any sensor that can map signal to temperature. In one example, a platinum Resistance Temperature Detector (RTD) sensor is employed. In another example, a Negative Temperature Coefficient (NTC) sensor is employed. In one example, transistor 14 performs as both the heater and the temperature sensor by switching the mode dynamically.

Operational amplified (op-amp) circuitry 53 can control the voltage drop over transistor 14 via feedback circuitry 58. In one example, where transistor 14 is a MOSFET, a small resistor on source terminal of the MOSFET is connected to ground. Op-amp circuitry 53 can then vary the gate voltage to control the voltage at the resistor. The effect is that an input voltage to op-amp circuitry 53 directly controls the current through the MOSFET while the drain voltage remains fixed, thereby giving variable power control.

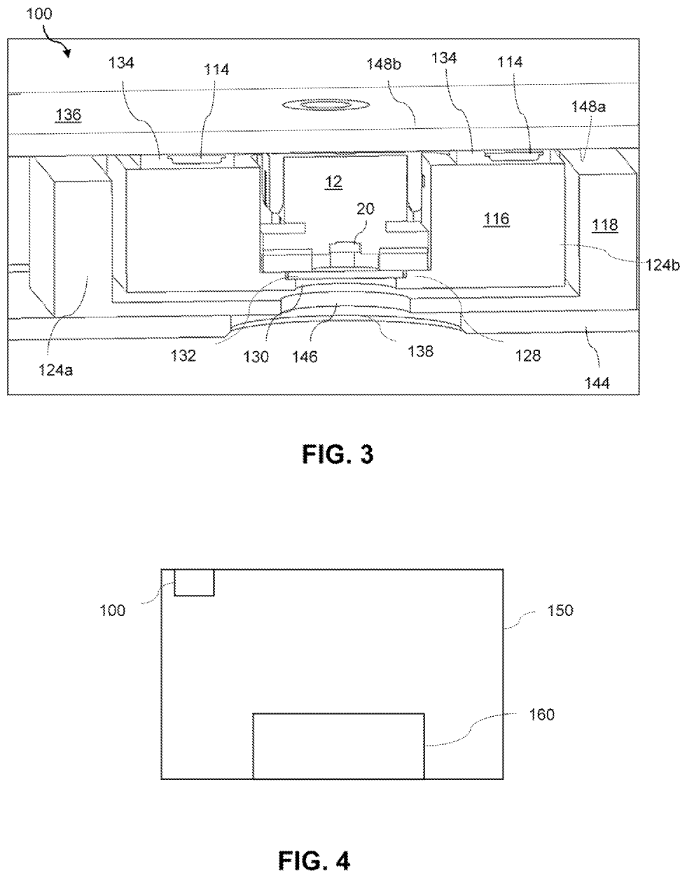

FIG. 3 is a perspective cross-sectional view of a thermal imaging assembly 100 according to another example of the present disclosure. Thermal imaging assembly 100 is similar to thermal imaging assembly 10 and includes many of the features described above. Thermal imaging assembly 100 includes a thermal imaging device 112, a transistor 114, a thermal jacket 116, and an insulative shell 118. Thermal imaging device 112 is seated into a cavity 122 of thermal jacket 116, within insulative shell 118, and can utilize convective and conductive thermal processes. Heat is conducted from transistor 114 to thermal jacket 116 and convectively transferred into the air space between thermal jacket 116 and thermal imaging device 112.

Transistor 114 can be powered by PCB 136 and provided adjacently or remotely from thermal imaging device 112. In one example, transistor 114 is a powered transistor and PCB 136 is employed. In some examples, both transistor 114 and thermal imaging device 112 can be mounted to a printed circuit board (PCB) 136. PCB 136 has a first side 148a and opposing second side 148b. In one example, thermal imaging device 112 and transistor 114 are mounted to first side 148a of PCB 136. Thermal imaging device 112 is mounted to PCB 136 to provide power and signal to thermal imaging device 112 as well as conduct heat into thermal imaging device 112. Thermal imaging device 112 can be socket mounted, or otherwise mountably secured, to PCB 136. Transistor 114 can include leads, or traces, on PCB 136 that conduct heat into thermal imaging device 112 from transistor 114. PCB 136 can include a thermal camera integrated circuit, a thermopile, a microcontroller, and variously other circuitry and components not specifically shown. A thermopile can be included to convert thermal energy into electrical energy, for example, when thermal imaging device 112 does not include an embedded temperature sensor. A microcontroller and/or circuits can be included to control the heat transfer to thermal imaging device 112 and form a control loop to actively control transistor 114 to affect the appropriate, or desired, temperature control of thermal imaging device 112 and can employ feed-back and feed-forward techniques.

In some examples, PCB 136 is disposed within housing, or enclosure, 144. In one example, thermal jacket 116 encompasses, or substantially encloses, surfaces of thermal imaging device 112 not disposed against PCB 136. Thermal jacket 116 extends around a perimeter of thermal imaging device 112, between PCB 136 and interior of 144, and across thermal imaging device 112 opposite the side attached to PCB 136. Thermal jacket 116 includes an opening 130 aligned with an opening of enclosure 146 and a sensor 120 of thermal imaging device 112. Thermal jacket 116 can be spaced or separated from PCB 136 by transistor 114 and a thermal interface 134. Thermal jacket 116 can extend to and contact thermal interface 134 for conduction of thermal energy from transistor 114. Insulative shell 118 extends around thermal jacket 116 and can be maintained within insulative shell 118 in a spaced relationship with minimal contact formed between thermal jacket 116 and insulative shell 118 to minimize conductive thermal losses into insulative shell 118. Insulative shell 118 can extend around thermal jacket 116, between thermal jacket 116 and housing 144 to form a thermal barrier. In some cases, insulative shell 118 extends toward PCB 136 in near contact with a minimized gap between to minimize any airflow into insulative shell 118. Insulative shell 118 has minimal contact with PCB 136 in order to minimize conductive loses into insulative shell 118.

FIG. 4 is a schematic view of thermal imaging assembly 100 within an additive manufacturing machine 150 according to an example of the present disclosure. Enclosure, or housing, 144 can substantially separate thermal imaging device 112 from the environment outside housing 144. Housing 144 along with thermal imaging assembly 110 disposed within housing 144, are used to isolate and protect thermal imaging device 112 from excessive or flexuating temperature and to keep contaminants from thermal imaging device 112. Housing 144 includes an opening to accommodate the field of view of the thermal imaging device oriented toward a build chamber 160 of additive manufacturing machine 150. Housing 144 can be formed of sheet metal or other suitable material. Housing 144 can provide for mounting of thermal image assembly 100 within additive manufacturing machine 150.

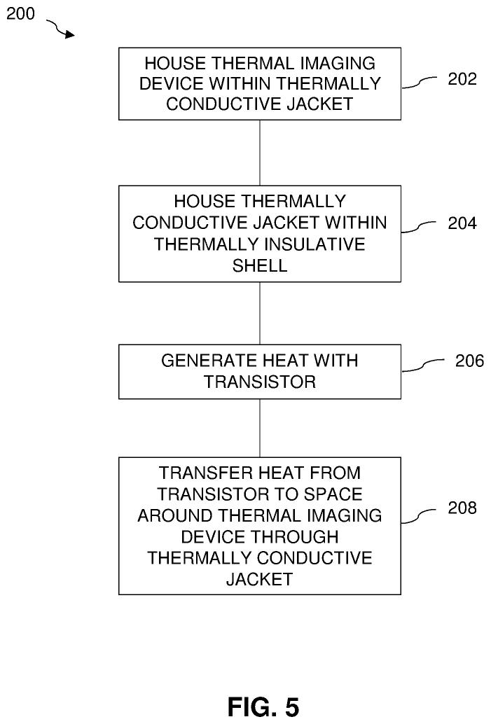

FIG. 5 is a flow chart of an example method 200 of controlling thermal conditions of a thermal imaging device according to an example of the present disclosure. At 202, the thermal imaging device is housed within a thermally conductive jacket, the thermally conductive jacket forming a space around the thermal imaging device. At 204, the thermally conductive jacket is housed within a thermally insulative shell, the thermally insulative shell forming a perimeter space around the thermally conductive jacket. At 206, heat is generated with a transistor thermally coupled to the thermally conductive jacket. At 208, heat is transferred from the transistor to the space around the thermal imaging device through the thermally conductive jacket.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A thermal imaging assembly, comprising:
a thermal imaging device including a thermal sensor;
a transistor to generate heat;
a thermal jacket forming a cavity to house the thermal imaging device, the thermal jacket forming a space around the thermal imaging device, the thermal jacket thermally coupled to the transistor to transmit heat generated by the transistor to the cavity; and
an insulative shell disposed around the thermal jacket to maintain a temperature of the thermal imaging device within the insulative shell.

2. The thermal imaging assembly of claim 1, wherein the thermal imaging device is a non-contact thermal imaging device.

3. The thermal imaging assembly of claim 1, comprising:
a thermal interface disposed between the transistor and the thermal jacket, the thermal interface to transmit heat generated by the transistor to the thermal jacket.

4. The thermal imaging assembly of claim 1, comprising:
a housing disposed around the insulative shell, the thermal imaging device and the transistor coupled to the printed circuit board within the housing.

5. The thermal imaging assembly of claim 1, comprising:
a thermopile mounted to the printed circuit board.

6. The thermal imaging assembly of claim 1, comprising:
a printed circuit board disposed along a first side of the thermal imaging device, and wherein the thermal jacket and insulative shell extend toward the printed circuit board around a side perimeter of the thermal imaging device.

7. A thermal measurement assembly for an additive manufacturing machine, comprising:
a thermal camera including a sensor to sense a thermal temperature profile within a build chamber of the additive manufacturing machine;
a transistor to generate heat;
a thermal jacket thermally conductively connected to the transistor, the thermal camera disposed in a cavity formed within the thermal jacket to transfer dissipated heat to the thermal camera; and
an insulative shell disposed around the thermal jacket, a perimeter spaced defined between the insulative shell and the thermal jacket.

8. The thermal measurement assembly of claim 7, wherein the thermal jacket comprises a ceramic filled silicon foam.

9. The thermal measurement assembly of claim 7, wherein the cavity defines a space around the thermal camera.

10. The thermal measurement assembly of claim 7, comprising:
a window disposed across an opening of the thermal jacket, the window positioned at a field of view of the sensor.

11. A thermal measurement assembly of claim 7, comprising:
a microcontroller coupled to a printed circuit board to control the transistor heat generation.

12. The thermal measurement assembly of claim 7, comprising:
circuits to control a temperature of the thermal camera.

13. A method of controlling thermal conditions of a thermal imaging device in an additive manufacturing machine, comprising:
housing the thermal imaging device within a thermally conductive jacket, the thermally conductive jacket forming a space around the thermal imaging device;
housing the thermally conductive jacket within a thermally insulative shell, the thermally insulative shell forming a perimeter space around the thermally conductive jacket;
generating heat with a transistor thermally coupled to the thermally conductive jacket; and
transferring heat from the transistor to the space around the thermal imaging device through the thermally conductive jacket.

14. The method of claim 13, comprising:
controlling the heat generation with a feedback control loop.

15. The method of claim 13, comprising:
maintaining the transistor on a printed circuit board disposed along an open side of the thermally conductive jacket.
